(19) United States
(12) Patent Application Publication
(10) Pub. No.: US 2010/0172402 A1
(43) Pub. Date: Jul. 8, 2010

(54) Content Distribution Systems and Methods

(75) Inventors: Gilles Bruno Marie Devictor, Milpitas, CA (US); Shlomo Selim Rakib, Cupertino, CA (US)

Correspondence Address: Stevens Law Group, 1754 Technology Drive, Suite #226, San Jose, CA, 95110, US

(73) Assignee: Novafora, Inc., San Jose, CA (US)

(21) Appl. No.: 12/414,586

(22) Filed: Mar. 30, 2009

Related U.S. Application Data
(63) Continuation-in-part of application No. 12/350,877, filed on Jan. 8, 2009.

(51) Int. Cl. H04N 11/02

(52) U.S. Cl. 375/240.01

(57) ABSTRACT

A content distribution system and method receives content from a content source and decodes the received content. The system and method identifies at least one undesired virtual channel associated with the received content and removes content associated with the undesired virtual channel. The remaining content is then consolidated into a consolidated frequency range, encoded, and distributed within a distribution environment.

### RELATED APPLICATIONS

This application is a continuation in part of, and claims the priority benefit of, U.S. patent application Ser. No. 12/350,877, titled “Content Distribution Systems and Methods”, filed Jan. 8, 2009, the disclosure of which is incorporated by reference herein.

### BACKGROUND

The invention relates generally to systems and methods for distributing content from a content source to a content destination. In particular, the described systems and methods receive content and identify an available channel or frequency segment for distributing the received content to a content destination, such as a display device having a tuner.

Using existing systems to wirelessly distribute content to a display device typically requires a specific wireless receiver located within the display device or coupled to the display device. For example, using existing systems to wirelessly distribute video content to a television requires a DMA (digital media adapter) or similar device to convert the broadcast signal to a signal format that can be processed by the television. This DMA may be incorporated into the television or a separate device coupled to the television. Requiring a DMA increases the cost to the consumer due to a more complex television or requiring the purchase of the separate DMA device. Such systems are also inconvenient as they may require a consumer to purchase different DMA devices (or purchase different televisions) to support new wireless distribution formats developed in the future.

Another approach to distributing content to a television using known systems utilizes existing cable television wiring within a building to distribute the desired content. Although the existing cable television wiring may be capable of distributing the content, such distribution may interfere with other signals transmitted on the same wiring by the cable service provider. Without appropriate management, such distribution of content may cause the improper operation of other systems or devices coupled to the same cable system.

### BRIEF DESCRIPTION OF THE DRAWINGS

FIG. 1 shows an example system capable of implementing content broadcasting.

FIG. 2 is a flow diagram showing an embodiment of a procedure for distributing content.

FIGS. 3A-3B show embodiments of a range of frequencies segmented into multiple broadcast physical channels and multiple shared white spaces.

FIG. 4 is a flow diagram showing an embodiment of a procedure for distributing two different programs to two different display devices simultaneously.

FIG. 5 is a flow diagram showing an embodiment of a procedure for implementing a remote desktop service.

FIG. 6 shows an example system capable of implementing content distribution within a distribution environment.

FIG. 7 is a flow diagram showing an embodiment of a procedure for managing channels associated with a cable network.

FIG. 8 is a flow diagram showing an embodiment of a procedure for managing data received from a cable service provider.

FIG. 9 is a flow diagram showing an embodiment of a procedure for distributing content.

FIG. 10 is a flow diagram showing an embodiment of a procedure for managing channels associated with a cable network and white space frequencies in a distribution environment.

FIG. 11 is a flow diagram showing an embodiment of a procedure for reassigning virtual channels in a distribution environment.

Throughout the description, similar reference numbers may be used to identify similar elements.

### DETAILED DESCRIPTION

The systems and methods described herein manage unused and/or undesired channels (or “frequency segments”) in a network and use those unused/undesired channels to communicate alternate content. Particular embodiments receive content from a content source and wirelessly distribute the content to a content destination. Other embodiments distribute the received content via existing wires using unused/undesired channels. In a particular implementation, the systems and methods receive video content from a content source, identify an available TV white space (or an available channel) for distributing the video content, and communicate the video content in an established standard format to one or more display devices capable of receiving, processing and displaying the video content. TV white space is the space between broadcast TV channels.

The described systems and methods distribute the video content to a display device, which can receive the content without requiring the use of a digital media adapter (DMA) located within the display device or coupled to the display device. Instead, the display device uses its existing tuner (or related components) to receive the distributed video content, thereby allowing legacy display devices to receive the video content without modification. Thus, the described systems and methods permit the distribution of content to any display device capable of tuning the appropriate frequency and decoding, if necessary, the distributed video content. The terms “broadcasting content” and “distributing content” are used interchangeably herein.

Although particular examples discussed herein refer to video content, video display devices, and the like, the systems and methods discussed herein can be used with any type of distribution device and any type of content destination capable of receiving and processing the distributed content. Specific embodiments discussed herein refer to video content, such as a television program or a movie. Alternate embodiments may process any type of content, such as audio content, graphical images, text content, and the like.

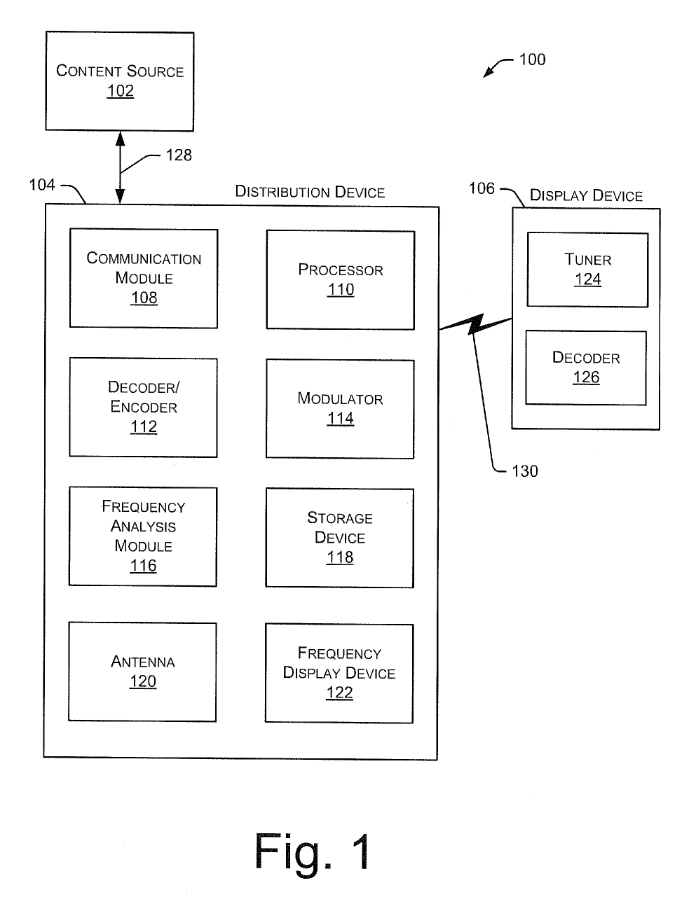

FIG. 1 shows an example system 100 capable of implementing content distribution as described herein. System 100 includes a content source 102, a distribution device 104 and a display device 106. Content source 102 is any system or service capable of providing content to distribution device 104. Content source 102 may be located remotely from distribution device 104 or may be local to distribution device 104. Content source 102 may provide any type of content, such as video content, audio content, text content, data content and the like. Example content sources 102 include databases, storage devices (e.g., hard disk drives), servers, content service providers, DVD players, Blu-ray Disc™ players, digital video recorders, audio players, game consoles, computing systems and so forth. Although one content source 102 is shown in FIG. 1, alternate embodiments may include any number of content sources 102 coupled to distribution device 104.

Content is communicated from content source 102 to distribution device 104 via a communication link 128 using any communication medium and any communication protocol. In a particular embodiment, content is streamed from content source 102 to distribution device 104 via the Internet or other data communication network. In another embodiment, content is retrieved from content source 102 by distribution device 104 via a wired or wireless communication link.

Distribution device 104 is capable of receiving content from content source 102, processing the received content as discussed herein, and distributing (also referred to herein as “broadcasting”) the content to one or more display devices 106, which display or otherwise present the content received from distribution device 104. In the described embodiments, distribution device 104 distributes content unidirectionally to one or more display devices 106. For example, distribution device 104 may wirelessly broadcast content in one direction from distribution device 104 to one or more display devices 106. Thus, distribution device 104 does not receive feedback signals (e.g., error checking signals, arbitration signals, and the like) from any display device 106. Any control feedback for distribution device 104 will use a separate communication link, such as an RF (radio frequency) signal from a remote control device.

Example display devices 106 include a monitor, television, or video projector. Content is communicated from distribution device 104 to display device 106 via a wireless communication link 130 using any communication protocol commonly supported by tuners contained in display devices. Example communication protocols include those developed by ATSC (Advanced Television Systems Committee) and NTSC (National Television System Committee). Although one display device 106 is shown in FIG. 1, alternate embodiments may include any number of display devices coupled to distribution device 104.

Distribution device 104 includes a communication module 108, a processor 110, a decoder/encoder 112, a modulator 114, a frequency analysis module 116, a storage device 118, an antenna 120 and a frequency display device 122. Although not shown in FIG. 1, these components of distribution device 104 communicate with one other via one or more communication links, such as buses, within distribution device 104. Communication module 108 communicates content and other data between distribution device 104 and other devices, such as content source 102, display device 106, and so forth. Processor 110 performs various operations necessary during the operation of distribution device 104. For example, processor 110 performs several methods and procedures discussed herein to retrieve, encode, modulate and distribute various content.

Decoder/encoder 112 decodes the content received from content source 102 and re-encodes it into one or more formats supported by display device 106, such as MPEG 2 (Moving Picture Experts Group) or H.264 (also referred to as MPEG4 AVC (advanced video coding)). Alternatively, decoder/encoder 112 may convert the received content into an analog standard definition television signal for use with legacy televisions. Modulator 114 modulates the encoded content generated by decoder/encoder 112 into one or more modulated formats, such as QAM (Quadrature Amplitude Modulation), 8VSB (8-level vestigial sideband modulation) for ATSC standards, or NTSC standards. Modulation using an NTSC standard is particularly useful when supporting legacy televisions. As discussed herein, frequency analysis module 116 identifies frequencies (or frequency segments) available for distributing the modulated content and selects an available frequency. Frequency analysis module 116 may identify available frequencies by analyzing the local spectrum and/or may use a database of available frequencies for its location. Storage device 118 stores data and other information used during the operation of distribution device 104. Storage device 118 may include one or more volatile and/or non-volatile memories. In a particular embodiment, storage device 118 includes a hard disk drive as well as volatile and non-volatile memory devices. Antenna 120 is used to transmit the modulated content from distribution device 104 to a display device 106. Antenna 120 transmits a low power signal to reduce the likelihood of interference with other TV white space devices. In alternate embodiments, antenna 120 is replaced by a transmitter or other communication device.

Frequency display device 122 displays the frequency selected for distributing content from distribution device 104 to display device 106 or to a remote control device. This displayed frequency information is applied by a user to tune the display device to an appropriate frequency or channel to receive the distributed content. In one embodiment, an IR (infrared) repeater is used to send channel control change signals to display device 106 from distribution device 104, thereby automatically tuning the appropriate channel on display device 106.

In particular embodiments of distribution device 104, one or more illustrated components represent computer-readable instructions that are executed, for example, by processor 1 10. For example, decoder/encoder 112, modulator 114 and frequency analysis module 116 may be implemented as computer-readable instructions that are executed by processor 110.

Distribution device 106 includes a tuner 124 and a decoder 126. Tuner 124 is capable of tuning multiple frequencies on which content may be distributed by distribution device 104. Decoder 126 decodes the received content using a decoding procedure that corresponds to the encoding format used by decoder/encoder 112 in distribution device 104. For example, decoder 126 may decode formats such as MPEG 2 or H.264. Although not shown in FIG. 1, tuner 124 and decoder 126 communicate with each other via one or more communication links within display device 106. In particular embodiments of display device 106, tuner 124 and/or decoder 126 are implemented as computer-readable instructions that are executed, for example, by a processor (not shown).

In a particular implementation, distribution device 104 is a general purpose computer system capable of performing the procedures described herein. In this implementation, content source 102 is an external storage device coupled to the general purpose computer, such as an external hard disk drive, a DVD player, or a Blu-ray Disc™ player. Alternatively, content source 102 is located remotely from the general purpose computer such that the general purpose computer receives content via the Internet or other data communication network. In this situation, the general purpose computer may temporarily store the received content on its internal storage device 118 to facilitate decoding, encoding, modulating and distributing the content to display device 106.

In another embodiment, content source 102 is contained within distribution device 104. In this embodiment, content source 102 is a storage device, such as a hard disk drive, a DVD drive, or a Blue-ray Disc™ drive contained within distribution device 104.

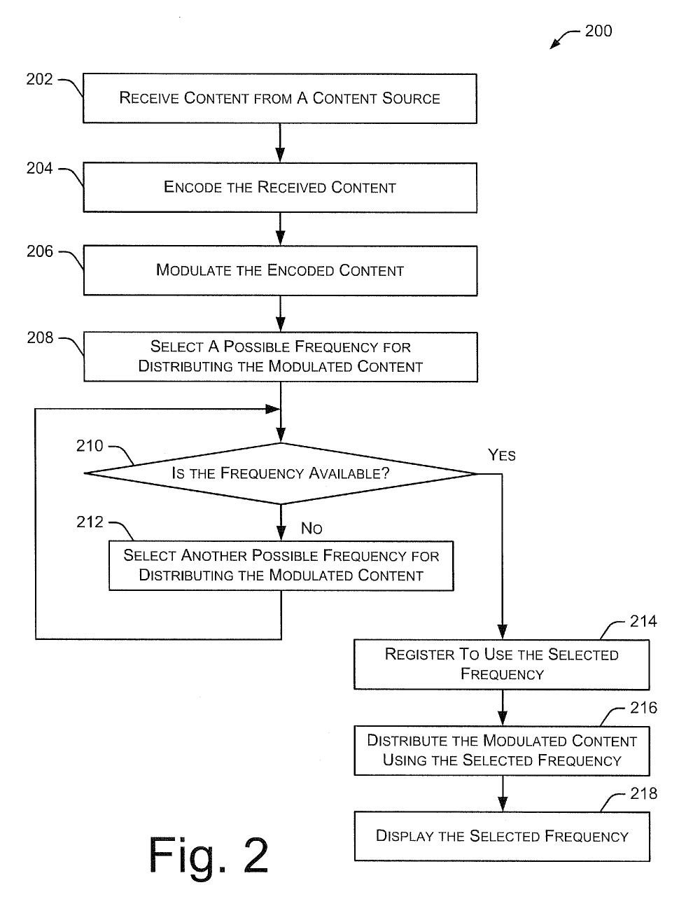

FIG. 2 is a flow diagram showing an embodiment of a procedure 200 for distributing content. Initially, procedure 200 receives content from a content source (block 202), such as content source 102 shown in FIG. 1. Content can be received via a “push” or a “pull” data transfer. For example, the content can be retrieved (e.g., pulled) from the content source by actively retrieving the desired content, such as retrieving content from a hard disk drive. Alternatively, the content can be “pushed” from the content source (e.g., “pushed” by a server via the Internet or other data communication network). Procedure 200 continues by encoding the received content (block 204). As mentioned above, various encoding techniques can be applied to the received content, such as MPEG2, H.264, or converting the content into an analog standard definition television signal for use with legacy televisions. In an alternate embodiment, the procedure first decodes the received content then encodes the content using an encoding format that can be decoded by a display device. After encoding the received content, the procedure modulates the encoded content (block 206). As mentioned above, various modulation techniques can be applied to the encoded content, such as QAM, ATSC, or NTSC (when supporting legacy televisions).

Procedure 200 continues by selecting a possible frequency for distributing the modulated content (block 208). As discussed herein, particular embodiments can select from multiple pre-defined frequencies for distributing the modulated content. Although there are several “possible” frequencies for distributing the modulated content, one or more of those frequencies may be in use by other systems. Thus, the procedure selects a first possible frequency and determines whether that selected frequency is available for distributing the modulated content (block 210). This determination regarding frequency availability is performed by “sniffing” the physical channel to identify “white noise” or to identify an active signal. A database of licensed frequencies for a given location can also be used to determine which frequencies are unlicensed and safe to “sniff”. When required by regulation, a geolocation device such as a GPS (global positioning system) can be added to frequency analysis module 116. If the procedure detects white noise, then the physical channel is available. If the procedure detects an active signal, then another device is using the selected physical channel, and a different frequency is selected. If the first selected frequency is not available, the procedure selects another possible frequency for distributing the modulated content (block 212). This frequency selection process continues until an available frequency is selected (i.e., a frequency that is not currently in use by another system). In a particular embodiment, the process of “sniffing” a physical channel is similar to the methods used by televisions and set-top boxes when performing channel lineup detection.

After an available frequency is selected, procedure 200 may registers to use the selected frequency (block 214) if such a registration is required. Registering the selected frequency prevents other systems from using that same frequency and interfering with distribution of the modulated content to the display device. This registration of the selected frequency may be temporary, such that the registration is released after distribution of the modulated content is complete. In a particular embodiment, distribution devices below a particular transmission power level (e.g., 50 mW) using TV white space do not need to register. However, distribution devices below the particular transmission power level may still access a database of TV white space devices to determine the availability of physical channels or other information.

After registering the selected frequency, procedure 200 distributes the modulated content using the selected frequency (block 216). Finally, the procedure displays the selected frequency (block 218), which allows a user to tune the display device to an appropriate frequency or physical channel to receive the distributed content. Although not shown in FIG. 2, when the procedure finishes distributing the modulated content using the selected frequency, it releases (or “unregisters”) the selected frequency to allow other systems to use the same frequency.

In a particular embodiment, the display device is capable of tuning multiple television channels, where each television channel is associated with a particular frequency (or frequency segment). User input (e.g., identifying a particular television channel) provided to the display device via a remote control device instructs the display device to display content associated with the particular television channel. If the user wants to view the distributed content (e.g., using procedure 200 discussed above), the user tunes the display device to the channel (or frequency) displayed at block 218.

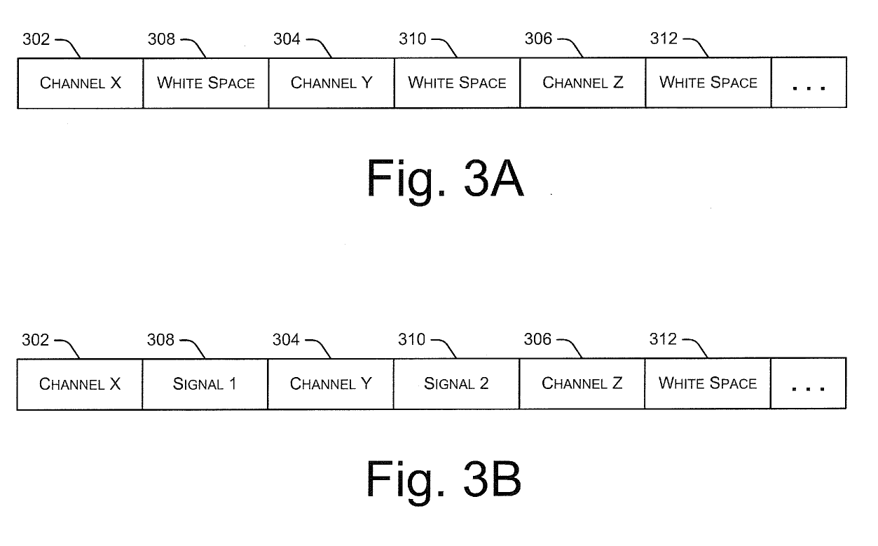

FIGS. 3A-3B show embodiments of a range of frequencies segmented into multiple physical channels and multiple shared white spaces (also referred to as “TV white spaces”). TV white spaces are the spaces between broadcast TV physical channels (e.g., the space between physical channel 2 and physical channel 3). In the example of FIG. 3A, a range of frequencies is illustrated as having multiple physical channels 302, 304 and 306, and multiple white space segments 308, 310 and 312. Physical channels 302, 304 and 306 may also be referred to as “frequency segments”. A frequency segment typically includes one or more physical channels, as shown by example in FIGS. 3A-3B. A physical channel can include one or more multiplexed programs such that each multiplexed program has an associated virtual channel, such as channel 7.1, channel 7.2 and so forth.

In a particular embodiment, physical channels 302, 304 and 306 are pre-determined frequency segments that have assigned channel indicators, such as “Channel 2” or “Channel 50” as used in conventional television broadcasts. In one embodiment, each physical channel 302, 304 and 306 has a frequency “width” of approximately 6 MHz. In this embodiment, each white space segment 308, 310 and 312 also has a frequency “width” of approximately 6 MHz.

White space segments 308, 310 and 312 are interspersed among physical channels 302, 304 and 306. White space segments 308, 310 and 312 are “shared” frequency segments available for use by multiple distribution devices. If a particular white space segment is available, a specific distribution device can temporarily reserve the white space segment (if reservation is required) for distributing content to one or more display devices. The distribution device releases the white space segment when it finishes distributing the content, thereby allowing other devices or systems to use the same white space segment.

The arrangement shown in FIG. 3A alternates between used physical channels and white space segments. In other embodiments, the used physical channels and white space segments may be arranged in a different order and are not necessarily alternating or in any other regular pattern. Although FIG. 3A identifies three specific physical channels 302, 304 and 306, and three specific white space segments 308, 310 and 312, alternate embodiments of a particular frequency range may include any number of channels and any number of white space segments arranged in any order.

FIG. 3B illustrates the range of frequencies shown in FIG. 3A in which two of the white space segments (308 and 310) are already used by a particular device. As shown in FIG. 3B, white space segment 308 is distributing data labeled “Signal 1” and white space segment 310 is distributing data labeled “Signal 2”. Thus, if a distribution device wants to distribute content using the range of frequencies shown in FIG. 3B, the distribution device can select white space segment 312, which is not currently being used.

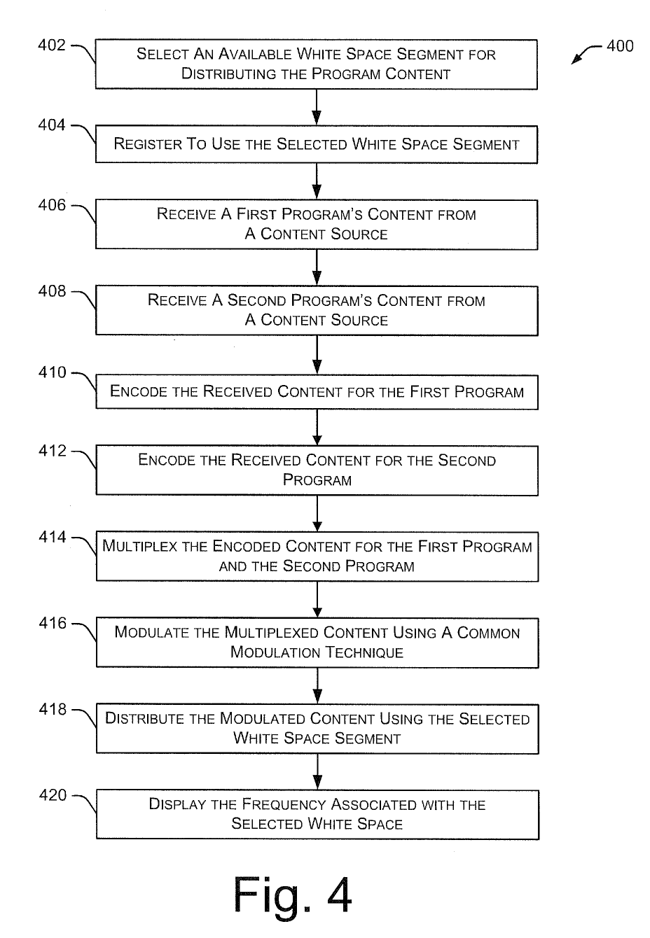

FIG. 4 is a flow diagram showing an embodiment of a procedure 400 for distributing two different programs to two different display devices simultaneously using a single white space segment of the type shown in FIGS. 3A and 3B. In a particular embodiment, the procedure of FIG. 4 distributes two different programs in HD (high definition) format, modulated using QAM, to the two display devices at the same time. Initially, procedure 400 selects an available white space segment for distributing the program content (block 402). As discussed herein, an available white space segment is one that is not already used by another TV white space system or device. If registration is required, the procedure registers to use the selected white space segment (block 404). If such registration is not required, this registration process can be omitted. Procedure 400 then receives a first program's content from a content source (block 406) and receives a second program's content from a content source (block 408). The first program content and the second program content may be received from the same content source or different content sources. Additionally, the first program and the second program need not be related to one another.

The procedure continues by encoding the received content for the first program (block 410) and encoding the received content for the second program (block 412). The first and second programs may be encoded using the same encoding format or they may be encoded using different encoding formats. In a particular example, the first program is encoded using a specific format supported by one display device, and the second program is encoded using a specific format supported by the other display device. If both display devices support the same encoding format, then the first and second programs can be encoded using the same format. In another embodiment, the encoding process discussed above with respect to block 410 can be omitted if the first program is already using a CODEC that is supported by the display device. In this embodiment, encoding is not necessary for the display device to receive and process the first program data.

Procedure 400 then multiplexes the encoded content for the first program and the second program (block 414). Next, the procedure modulates the multiplexed content for the first and second programs using the same modulation technique (block 416). For example, the first and second programs can be multiplexed as two adjacent digital subchannels (or virtual channels), such as 36.1 and 36.2. The procedure continues by broadcasting the modulated content using the selected white space segment (block 418). Since two different programs are broadcast in the selected white space segment, the display device 106 uses the subchannel PID (packet identifier) to extract the video program intended for that device in the same manner that a digital TV or set-top box extracts several subprograms from a single physical 6 MHz signal. The subchannel PID associates a particular packet with a program (or other content) within the transport stream. In a particular embodiment, the identifier associated with each program is the ATSC PID. For example, if the selected white space is associated with physical channel 36, the first program has an associated virtual channel number of 36.1 and the second program has an associated virtual channel number of 36.2. Finally, the procedure displays the frequency associated with the selected white space (block 420). In the example mentioned above (using virtual channel numbers 36.1 and 36.2), procedure 400 may alternately display the two virtual channel numbers (e.g., 36.1 and 36.2) associated with the two programs.

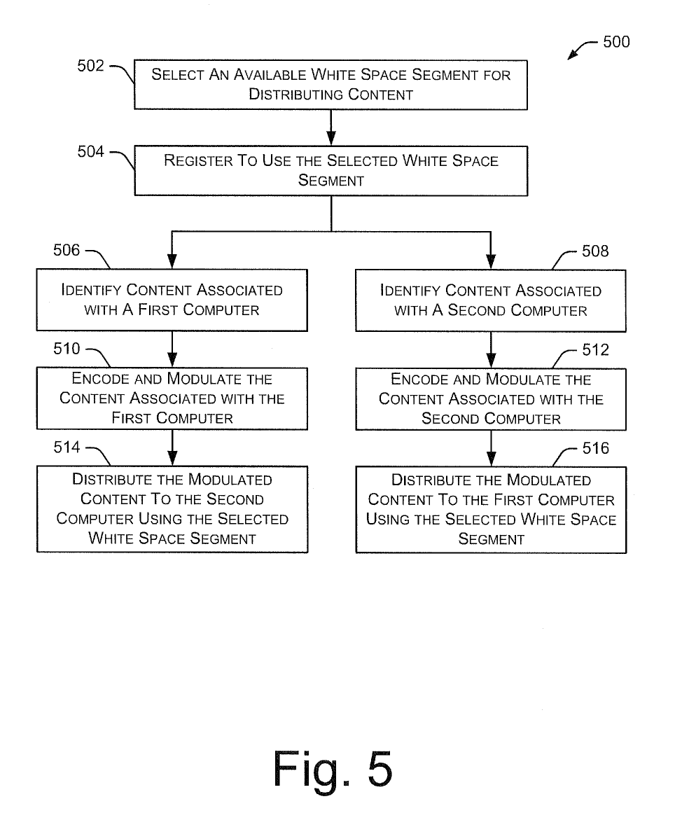

FIG. 5 is a flow diagram showing an embodiment of a procedure 500 for implementing a remote desktop service between two computer systems. A remote desktop service allows a user of one computer to access a remote computer system and control the remote computer system. The user's local computer system typically displays what the user would see if physically present at the remote computer system. In the embodiment of FIG. 5, the procedure is capable of communicating data between the two computer systems by establishing two separate distribution links (one distribution link from the first computer to the second computer, and a second distribution link from the second computer to the first computer). This embodiment supports the distribution of high quality video content between the two computers (e.g., video content at approximately 60 frames per second or better) by using two separate white space segments.

Initially, procedure 500 selects an available white space segment for distributing content (block 502). In one embodiment, a separate white space segment is used for each distribution of content. Procedure 500 continues by registering to use the selected white space segment (or segments) at block 504 if required by regulation or otherwise required. The procedure then begins the remote desktop service by allowing a first computer and a second computer to exchange data via two separate one-way distribution links (one distribution link from the first computer to the second computer, and the other distribution link from the second computer to the first computer). In this embodiment, the “desktop” of one computer can be encoded as video content and distributed as a television program to the other computer. Similarly, a PID can be used to identify content as data to be broadcast from one computer to the other.

Blocks 506 and 508 identify content associated with a first computer and a second computer, respectively. Blocks 510 and 512 encode and modulate the content associated with the first computer and the second computer, respectively. Finally, blocks 514 and 516 distribute the modulated content to the second computer and the first computer using the selected white space segment, respectively. Blocks 506, 510 and 514 are typically performed in parallel with blocks 508, 512 and 516. This process of identifying content, encoding content, modulating content and distributing content continues for the duration of the remote desktop session.

In another embodiment of a remote desktop service, a first computer is the “controller” and a second computer is the “source”. The source will distribute its content and display information to the controller using a high speed connection, such as described herein. The controller can use a lower speed connection to send control commands (e.g., keyboard inputs) to the source computer. This embodiment uses a single white space segment.

An alternate embodiment of a remote desktop service uses a single white space segment and multiplexes the white space segment in time. A first computer transmits data during a first time period (such as the first 800 milliseconds), then a second computer transmits data during a second time period (such as the next 200 milliseconds). This embodiment supports two separate transport streams using the same white space segment, but separated in time. Each computer can use the entire 6 MHz of the white space segment, but only during its assigned time slot. In a particular example, both computers buffer received video content to smooth the content before displaying the content to a user. Any number of computers can share a single white space segment in the same manner by multiplexing the white space segment in time. Multiple time slots can be allocated using a round robin technique or any other allocation technique.

In one embodiment, distribution device 104 shown in FIG. 1 is a computer capable of performing various operations. In this embodiment, the computer is operating as a digital video recorder (DVR) without requiring the addition of any new devices to the computer. For example, the computer uses its existing hard disk drive, processor and other components to implement the DVR functionality. The computer performs some or all of the procedure shown in FIG. 2, as needed, to wirelessly communicate content from the computer to one or more display devices located in the same general area as the computer, such as in the same building or local geographic area. While operating as a DVR, the computer is able to perform other operations simultaneously. The computer may also be configured to operate as a multi-room DVR without requiring any additional adapters or other devices for existing televisions or set-top boxes. The computer distributes two or more programs (or other content) to different display devices, each of which as a tuner to receive the content. A single computer operating as a DVR can distribute multiple programs within a single white space segment based on the bandwidth allowed by the modulation technique.

In another embodiment, content distribution is performed via cabling within a distribution environment. The distribution environment includes a building (such as a house, office building, or other structure), a group of buildings, or a geographic region (such as a campus or neighborhood). The cabling on which content is distributed may include coax cable used to distribute cable television-based signals, satellite signals, and the like. The cabling may also include telephone lines, power lines, and any other communication links capable of communicating data within the distribution environment.

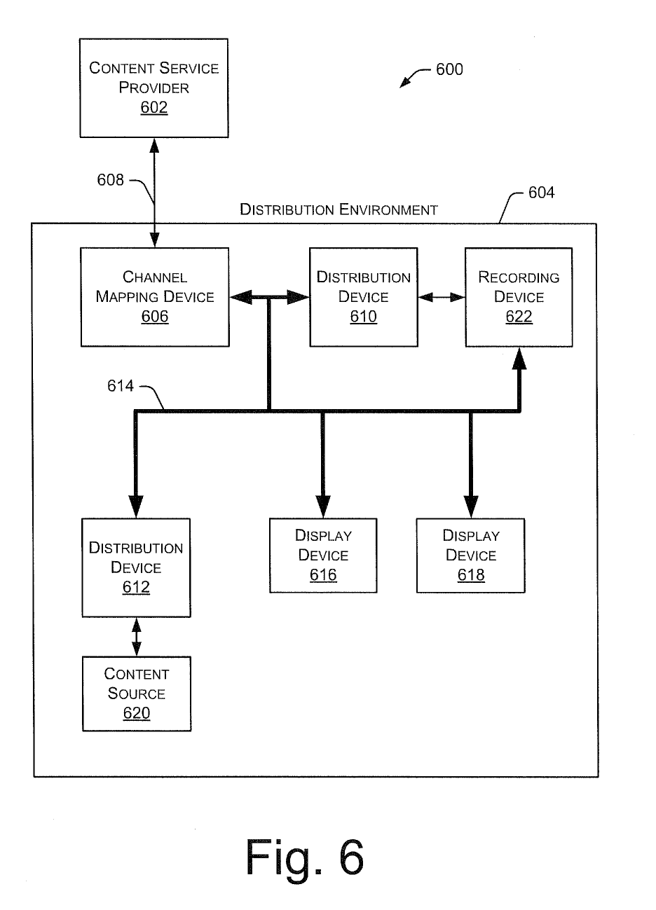

FIG. 6 shows an example system 600 capable of implementing content distribution within a distribution environment. In the embodiment of FIG. 6, a content service provider 602 provides content and other data to multiple recipients, such as customers, subscribers, clients, and the like. A particular recipient is identified in FIG. 6 as distribution environment 604. As mentioned above, distribution environment 604 can include a building, group of buildings, or a geographic region. A particular embodiment of system 600 is described below defines distribution environment 604 as a building, such as a house or office building. In this particular embodiment of system 600, content service provider 602 is a cable television service provider that provides cable television signals and other data to distribution environment 604. The cable television service provider may provide additional services such as Internet access, voice over IP (VOIP) telephone service, and so forth.

A channel mapping device 606 in distribution environment 604 receives content and other data from content service provider 602 via a communication link 608. Communication link 608 may utilize any communication medium and any communication protocol. In a particular embodiment, communication link 608 includes multiple communication links coupled to one another in a manner that allows a cable television service provider to distribute content and other data to multiple subscribers.

Channel mapping device 606 receives data from content service provider 602 and identifies any unused physical channels in the cable network. For example, the received data may identify 200 different channels of content, but only utilize 170 of those channels. Channel mapping device 606 identifies the unused physical channels and filters out any data or noise contained in those unused channels. Filtered channels are removed from distribution environment 604 by the channel mapping device. Additionally, channel mapping device 606 may identify channels that are undesirable to the users within distribution environment 604. For example, a user may not want to watch online shopping channels or channels that broadcast content in a particular language that is not understood by the user. One or more users identify these undesirable channels to the channel mapping device 606, which filters out any data contained in those undesirable physical channels. If all virtual channels in a physical channel are undesirable, the entire physical channel can be filtered. Channel mapping device 606 then generates a map of free physical channels and distributes that map to other devices within distribution environment 604. As discussed herein, these free physical channels are available for transmitting alternate content within distribution environment 604. In a particular embodiment, channel filtering is limited to a particular number of channels. For example, in a system where 10 frequency segments are unused and two distribution devices are used, the channel mapping device may limit its filtering to two frequency segments (one for each distribution device). Each of these filtered frequency segments may include one or more programs.

Channel mapping device 606 is coupled to distribution device 610 and 612, display devices 616 and 618, and a recording device 622 via a communication link 614. In a particular embodiment, communication link 614 uses physical cables or wires within distribution environment 604. Example physical wires or cables include coaxial cable commonly used to distribute cable television or satellite signals, telephone wires, power distribution lines, and the like. Signals can be modulated using QAM, 8VSB, or any other modulation method. Distribution devices 610 and 612 are substantially similar to distribution device 104 described herein. Display devices 616 and 618 are substantially similar to display device 106 described herein. The display devices receive the modulated content using its built-in tuner. Although two distribution devices 610, 612 and two display devices 616, 618 are shown in FIG. 6, alternate embodiments may include any number of distribution devices and any number of display devices coupled to one another in any manner.

A content source 620 is coupled to distribution device 612 and provides various types of content to distribution device 612 for distribution to other devices in distribution environment 604. Content source 620 may be similar to content source 102 described herein. A recording device 622 is coupled to distribution device 610 and communication link 614. Recording device 622 receives content from one or more distribution devices and stores the content for future distribution. The content stored by recording device 622 is available for future distribution to a display device or other device via a distribution device or directly from the recording device. Recording device 622 may also be referred to as a “redistribution device”. The recording device may be a digital video recorder (DVR), DVD recorder, or any other device capable of storing received content. Although one content source 620 and one recording device 622 is shown in FIG. 6, alternate embodiments may include any number of content sources and any number of recording devices.

In a particular embodiment of FIG. 6, the devices in distribution environment 604 are capable of communicating via communication link 614 as well as one or more additional communication mechanisms. For example, distribution devices 610 and 612 may distribute content to display devices 616 and 618 via communication link 614 or via a wireless communication system, such as the TV white space systems and methods discussed herein.

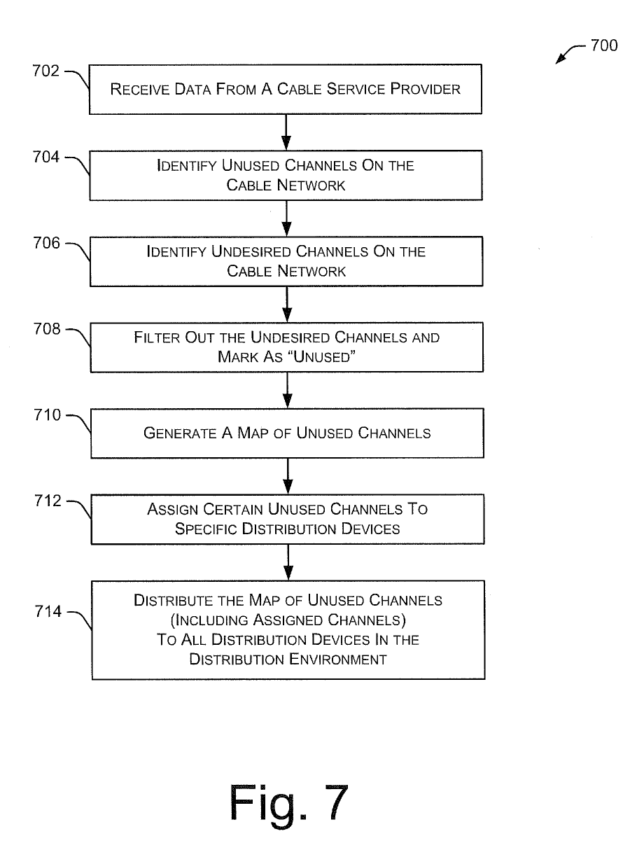

FIG. 7 is a flow diagram showing an embodiment of a procedure 700 for managing channels associated with a cable network. Initially, procedure 700 receives data from a cable service provider (block 702). This data may include television program content as well as other information, such as channel information, program information, and so forth. The procedure then identifies unused channels on the cable network (block 704). These unused channels may be identified by the cable service provider or may be detected by, for example, channel mapping device 606 by “channel sniffing” to identify channels with no data or channels with static or noise. Alternatively, unused channels may be identified using a channel guide in combination with knowledge of channels to which the user subscribes.

Different embodiments of channel mapping device 606 may perform different levels of filtering and other operations. For example, one embodiment of channel mapping device 606 detects unused physical channels, filters noise, and generates a channel map. Another embodiment of channel mapping device 606 filters one or more physical channels composed of undesirable virtual channels or programs. Yet another embodiment of channel mapping device 606 additionally consolidates multiple virtual channels into fewer physical channels.

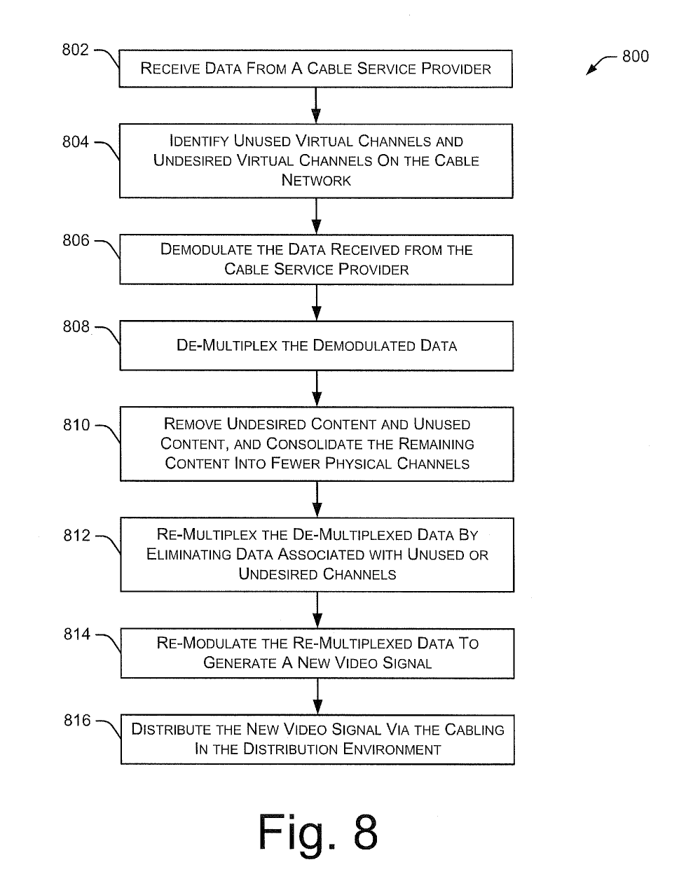

Procedure 700 continues by identifying undesired channels on the cable network (block 706). Undesired channels may include channels that are not of interest to the subscriber due to content, language, or other parameter. For example, a subscriber may not be interested in channels on a particular topic or channels broadcast in certain languages. The procedure filters out the undesired channels and identifies those channels as “unused” (block 708). Identifying one or more channels as “unused” may also be referred to as “tagging” or “marking” the channels. Filtering out the undesired channels includes removing any data received from the cable service provider on those channels and making the channels available for use in communicating other data. Additional details regarding filtering undesired channels is discussed below with respect to FIG. 8.

The procedure of FIG. 7 continues by generating a map (or other listing) of unused channels (block 710). This map of unused channels includes unused channels on the cable network (identified at block 704) and undesired channels (identified at block 706). Procedure 700 then assigns certain unused physical channels to specific distribution devices (block 712). This assignment of unused channels allows a specific distribution device to communicate data to other distribution devices, display devices, recording devices, and so forth within the distribution environment. Finally, procedure 700 distributes the map of unused channels, including the assignment of certain unused channels to specific distribution devices, to all distribution devices in the distribution environment (block 714). For example, channel mapping device 606 (FIG. 6) can distribute a map of unused channels and related information to distribution devices 610, 612, and recording device 622 in distribution environment 604. The distribution of the mapping information can be communicated wirelessly, via the cable wires, or through any other communication medium.

In certain situations, channels that carry undesired content (or no content) can be filtered out completely as discussed herein. In other situations, it may be advantageous to use other procedures (such as the procedure of FIG. 8 discussed below) to generate additional channels (or frequency segments) to communicate additional content within the distribution environment.

FIG. 8 is a flow diagram showing an embodiment of a procedure 800 for managing data received from a cable service provider. This procedure represents one embodiment for filtering undesired virtual channels from data received from the service provider. Initially, procedure 800 receives data from a cable service provider (block 802). The procedure identifies unused virtual channels in the received data as well as undesired virtual channels on the cable network (block 804). As mentioned herein, undesired virtual channels can be identified by a subscriber based on the subscriber's viewing preferences, language preferences, and so forth. Unused virtual channels may include unsubscribed channels.

Procedure 800 continues by demodulating the data received from the cable service provider (block 806) and de-multiplexing the demodulated data (block 808). This demodulation and de-multiplexing of data is referred to collectively as “decoding” the data. At this point, any undesired programs and content (or noise) associated with unused/undesired virtual channels is removed, so the remaining content can be consolidated into fewer physical channels (block 810). After performing these operations, the procedure re-multiplexes the de-multiplexed data by eliminating data associated with unused or undesired channels (block 812). Next, the re-multiplexed data is re-modulated to generate a new video signal (block 814) for distribution within the distribution environment. This new video signal requires fewer physical channels, enabling the channel mapping device to allocate the newly freed frequency segments to the distribution devices. Finally, the new video signal is distributed within the distribution environment via the existing cabling (block 816). The re-multiplexing and re-modulating of data is referred to collectively as “encoding” the data.

The procedure of FIG. 8 reduces the likelihood of interference with data received from the cable service provider because the procedure specifically removes certain channels and controls which channels are used within the distribution environment. If the cable service provider adds a new channel or changes existing channels, the systems and methods described herein can override those changes by filtering out the new channel and managing any changes to existing channels during the de-multiplexing/demodulating and re-multiplexing/re-modulating operations.

In a particular implementation, the channel mapping device “moves” certain channels by remapping them to different physical channels. This ensures that certain physical channels are always available and can be assigned to distribution devices in a static manner. For example, physical channel 21 may be assigned to a first distribution device and physical channel 25 is assigned to a second distribution device. If the cable service provider begins communicating content on physical channel 21 or physical channel 25, the channel mapping device moves that content from the cable service provider to another physical channel.

In certain embodiments, the channel mapping device may also function as a distribution device. For example, the channel mapping device may be considered as a distribution device for all received content from the content service provider. Physical channels not assigned to a particular distribution device are assigned to the channel mapping device. The channel mapping device can also combine content from multiple sources (e.g., multiple content providers) for distribution within the distribution environment.

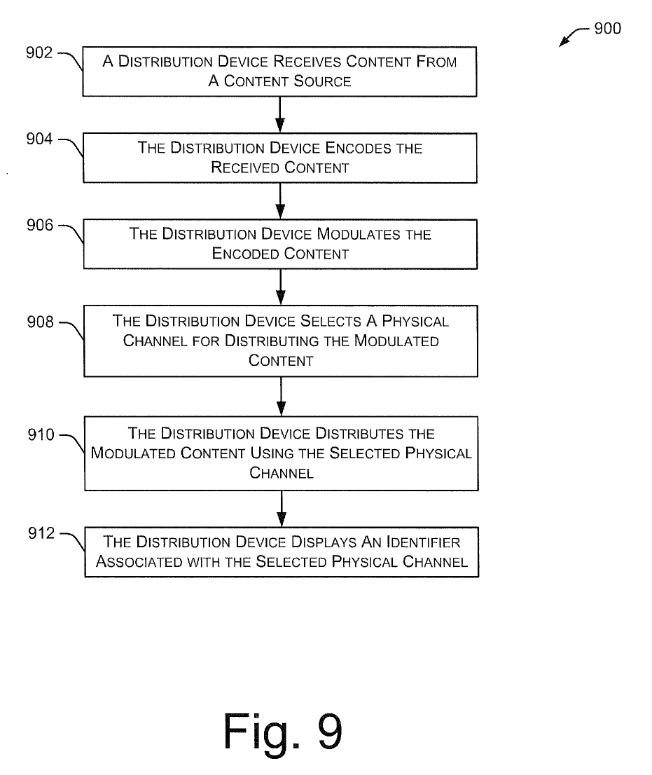

FIG. 9 is a flow diagram showing an embodiment of a procedure 900 for distributing content. Initially, a distribution device receives content from a content source (block 902). The distribution device encodes the received content (block 904) and modulates the encoded content (906). Next, the distribution device selects a physical channel for distributing the modulated content (908) to other distribution devices, display devices, or components within the distribution environment. In a particular embodiment, the particular distribution device may have one or more assigned physical channels for distributing the modulated content. Procedure 900 continues as the distribution device distributes the modulated content using the selected physical channel (910). Finally, the distribution device displays an identifier associated with the selected physical channel (block 912). This selected channel identifier is for the benefit of a user that needs to tune a display device or other component to receive the distributed content on the appropriate channel.

In a particular embodiment, physical channels are allocated to distribution devices in a static manner. In this embodiment, the physical channel information need not be communicated to other devices in the distribution environment. Each display device will perform a channel scan, thereby mapping the appropriate distribution device in its channel listings. In another embodiment, the distribution device can broadcast metadata that identifies itself and its content. In this embodiment, each distribution device may appear to a user as one or more television channels.

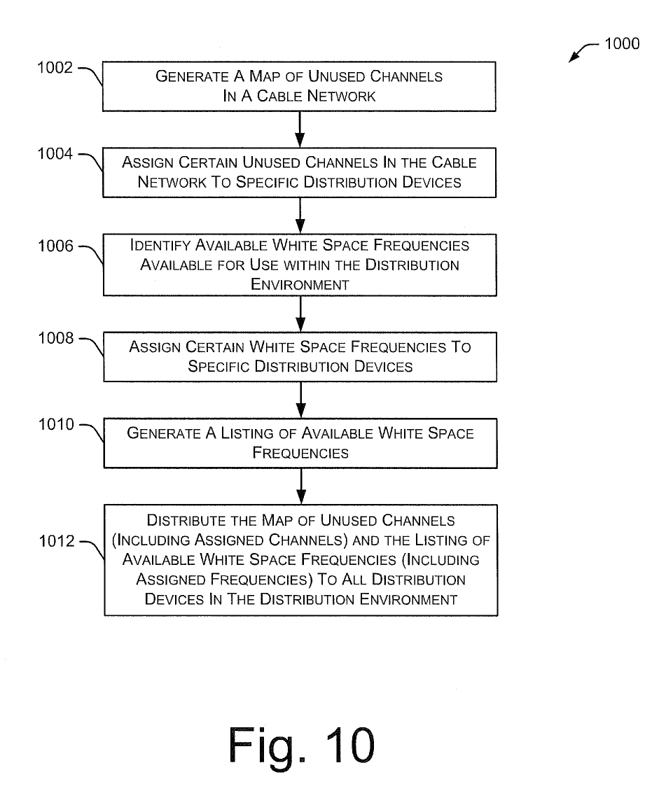

FIG. 10 is a flow diagram showing an embodiment of a procedure 1000 for managing channels associated with a cable network and white space frequencies in a distribution environment. The procedure begins by generating a map of unused channels in a cable network (block 1002). One or more unused channels in the cable network are assigned to specific distribution devices or other components in the distribution environment (block 1004). Procedure 1000 then identifies white space frequencies available for use within the distribution environment (block 1006). One or more of the identified white space frequencies are assigned to specific distribution devices or other components in the distribution environment (block 1008). The procedure continues by generating a listing of available white space frequencies (1010). Finally, procedure 1000 distributes the map of unused channels (which includes any assigned channels) and the listing of available white space frequencies (which includes any assigned frequencies) to all distribution devices and other components in the distribution environment (block 1012).

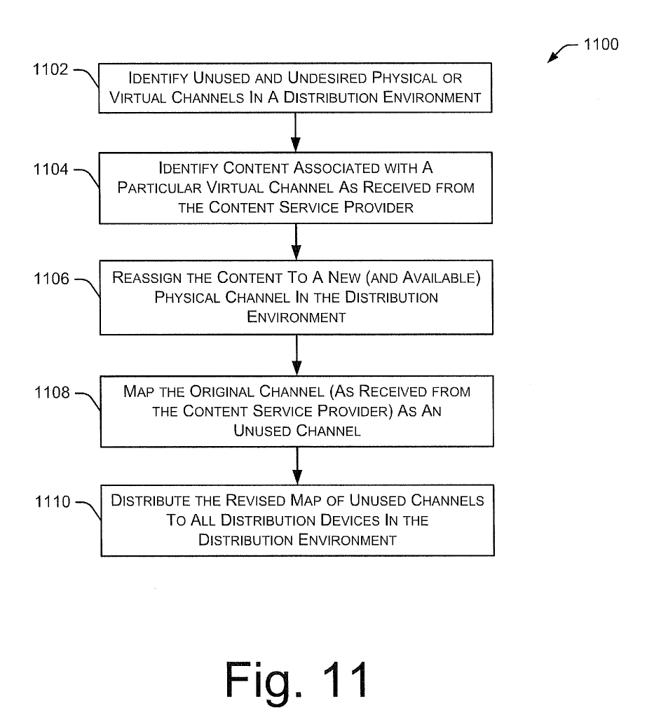

FIG. 11 is a flow diagram showing an embodiment of a procedure 1100 for reassigning virtual channels in a distribution environment. Initially, the procedure identifies unused and/or undesired physical or virtual channels in a distribution environment (block 1102) (for example, it might identify virtual channel 98.1 on physical channel 10 as undesirable). Example systems and methods to identify unused and/or undesired physical and virtual channels are described herein. The procedure continues by identifying content associated with a particular virtual channel as received from the content service provider (block 1104). For example, a cable television content provider may assign “The Ocean Channel” to virtual channel 125.1 and physical channel 9. Procedure 1100 reassigns the content (e.g., The Ocean Channel content) to a new (and available) physical channel in the distribution environment (block 1106). In one embodiment, the new channel is an unused or undesired channel. For example, The Ocean Channel may be reassigned from physical channel 9 to physical channel 10, or any other available channel in the distribution environment. This reassignment of channels occurs within the distribution environment and does not alter channel information provided by the content service provider to other customers or subscribers. It also does not alter the virtual channel assignment. In this example, the Ocean Channel will still appear as virtual channel 125.1 to the user. A new channel scan may be necessary on each display device to obtain the revised channel information.

The procedure of FIG. 11 then maps the original channel as received from the content service provider as an unused channel (block 1108). In the above example, original virtual channel 125. 1 is reassigned to physical channel 10, thereby releasing physical channel 9 for communication of alternate content. The revised mapping of channel information (e.g., unused channels, undesired channels and reassigned channels) is then distributed to all distribution devices in the distribution environment (block 1110). In one embodiment, the channel mapping device broadcasts the mapping information using a self-assigned physical channel (for example physical channel 3 or 4). Display devices can use their built-in channel scanning function to internally re-associate physical and virtual channels.

In a particular implementation, channels are reassigned such that a viewer's favorite channels are grouped together in a consecutive sequence of channel numbers. For example, a viewer's 10 favorite channels may be reassigned as channels 1-10, regardless of the original channel number assigned to those channels by the content service provider. In another example, one or more physical channels can be moved without changing the virtual channel assignments. Additionally, the virtual channel assignment can be modified during the multiplexing operation.

Other implementations may assign a recording device, such as a digital video recorder to an available physical channel. For example, a DVR containing stored content is assigned to physical channel 10 (or another “Top 10” channel) since the DVR is likely to contain content of interest to the viewer. Thus, the DVR content is accessible to all distribution devices within the distribution environment via the dedicated channel. In some embodiment, the distribution device will broadcast more than one virtual channel on a single physical channel using multiplexing: An example would be a DVR broadcasting two recordings on physical channel 10. One recording will appear to the user as virtual channel 10.1, the other one as virtual channel 10.2.

In another embodiment, channel mapping device 606 modifies the encoding of content received from the content service provider. In this embodiment, the channel mapping device receives content encoded using a particular CODEC, and transcodes that content to a more efficient CODEC understood by one or more display devices within the distribution environment. For example, content may be distributed by the content service provider using two channels in MPEG2 format. The channel mapping device receives the content on those two channels and transcodes the content into another format, such as H.264, and remodulates the content using a single channel. This process releases one of the two channels used to transmit the MPEG2 data, thereby allowing the released channel to communicate other content within the distribution environment.

Another implementation reduces the quality of one or more rarely watched virtual channels (e.g., using quantization). In this implementation, each of the rarely watched virtual channels will require a lower bit rate and certain physical channels can be consolidated. This frees one or more physical channels for use in distributing alternate content by the distribution devices.

The invention may also involve a number of functions to be performed by a computer processor, such as a microprocessor. The microprocessor may be a specialized or dedicated microprocessor that is configured to perform particular tasks according to the invention, by executing machine-readable software code that defines the particular tasks embodied by the invention. The microprocessor may also be configured to operate and communicate with other devices such as direct memory access modules, memory storage devices, Internet related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of devices, such as laptop or desktop computers, hand held devices with processors or processing logic, and also possibly computer servers or other devices that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to the invention as described herein enable the physical transformation of these memory devices. Accordingly, the invention as described herein is directed to novel and useful systems and methods that, in one or more embodiments, are able to transform the memory device into a different state. The invention is not limited to any particular type of memory device, or any commonly used protocol for storing and retrieving information to and from these memory devices, respectively.

Embodiments of the systems and methods described herein facilitate the distribution of content, such as video content, to one or more content destinations without a need for additional reception hardware. Additionally, some embodiments may be used in conjunction with one or more conventional video processing and/or video display systems and methods. For example, one embodiment may be used as an improvement of existing video processing systems.

Although the components and modules illustrated herein are shown and described in a particular arrangement, the arrangement of components and modules may be altered to perform the distribution of content in a different manner. In other embodiments, one or more additional components or modules may be added to the described systems, and one or more components or modules may be removed from the described systems. Alternate embodiments may combine two or more of the described components or modules into a single component or module.

Although specific embodiments of the invention have been described and illustrated, the invention is not to be limited to the specific forms or arrangements of parts so described and illustrated. The scope of the invention is to be defined by the claims appended hereto and their equivalents.

1. A method comprising:
receiving content from a content service provider;
decoding the content received from the content service provider;
identifying at least one undesired virtual channel associated with the content received from the content service provider;
removing content associated with the at least one undesired virtual channel;
consolidating remaining content into a consolidated frequency range;
encoding the remaining content to generate encoded content; and
distributing the encoded content within a distribution environment.

2. The method of claim 1, wherein the encoded data is distributed within the distribution environment via existing cable transmission lines in the distribution environment.

3. The method of claim 1, wherein the encoded data is distributed wirelessly within the distribution environment.

4. The method of claim 1, wherein the encoded data is distributed within the distribution environment via existing cable transmission lines in the distribution environment and via wireless transmission.

5. The method of claim 1, wherein decoding the content received from the content service provider includes demodulating the content received from the content service provider to generate demodulated content and demultiplexing the demodulated content.

6. The method of claim 1, wherein encoding the remaining content to generate encoded content includes multiplexing the consolidated remaining content.

7. The method of claim 1, wherein encoding the remaining content to generate encoded content includes encoding the remaining content using a different encoding technique than associated with the content received from the content service provider.

8. A method comprising:
receiving content from a content provider, wherein the received content includes a plurality of associated channels;
identifying a first channel associated with a first portion of received content;
identifying a second channel available for communication within a distribution environment;
reassigning the first channel to the second channel; and
mapping the first channel as an available content transmission channel.

9. The method of claim 8, further comprising:
receiving content from a content source within the distribution environment;
encoding the received content to generate encoded content;
modulating the encoded content to generate modulated content; and
distributing the modulated content within the distribution environment using the first channel.

10. The method of claim 8, further comprising distributing the revised channel mapping information to at least one device within the distribution environment.

11. An apparatus comprising:
a distribution device configured to distribute content to at least one display device within a distribution environment; and
a receiving device coupled to the distribution device, the receiving device configured to receive content including a plurality of channels from a content provider and identify a first channel associated with a first portion of received content, the receiving device further to reassign the first channel to a second channel and identify the first channel as an available transmission channel for communicating alternate content within the distribution environment.

12. The apparatus of claim 11 wherein the distribution device further receives content from a content source within the distribution environment and encodes the received content to generate encoded content, and wherein the distribution device further modulates the encoded content to generate modulated content and distributes the modulated content within the distribution environment using the first channel.

13. The apparatus of claim 12 wherein the distribution device encodes the received content using an encoding format that can be decoded by the at least one display device.

14. The apparatus of claim 11 wherein the receiving device further distributes reassigned channel information to a plurality of distribution devices within the distribution environment.

15. The apparatus of claim 11 wherein the distribution device and the receiving device communicate via a wireless communication link.

16. The apparatus of claim 11 wherein the distribution device and the receiving device communicate via existing wired communication links within the distribution environment.
